(19) United States
(12) Patent Application Publication
(10) Pub. No.: US 2007/0100671 A1
(43) Pub. Date: May 3, 2007

(54) Method and apparatus for curriculum exclusive booking in a curriculum management system

(76) Inventors: Holger Bohle, Dielheim (DE); Simone Buchwald, Heidelberg (DE); Silke Gruber, Sinsheim (DE); Marcus Philipp, Dielheim (DE)

Correspondence Address: RICHARD F. JAWORSKI;Cooper & Dunham LLP, 1185 Avenue of the Americas, New York, NY, 10036, US

(21) Appl. No.: 11/262,871

(22) Filed: Oct. 31, 2005

(51) Int. Cl. G06Q 10/00

(52) U.S. Cl. 705/5

(57) ABSTRACT

Method and apparatus for curriculum exclusive booking is provided. A request is received for booking a course and based on a value of a first booking option it is determined whether the course is allowed to be booked, whether the course is bookable only as part of a curriculum, or whether the course is bookable depending on a value of a second booking option. If it is determined that the course is bookable depending on the value of the second booking option, it is determined whether the course is allowed to be booked or whether the course is bookable only as part of a curriculum. The request is processed based on the value of the first booking option or the value of the second booking option.

### BACKGROUND OF THE DISCLOSURE

### TECHNICAL FIELD

The present disclosure relates generally to curriculum management and, more particularly, to a method and apparatus for curriculum exclusive booking in a curriculum management system.

### DESCRIPTION OF THE RELATED ART

Electronic learning systems (“ELS”) provide users with the ability to access course content directly from their computers, without the need for intermediaries, such as teachers, tutors, and the like. Such computer-based systems have proven attractive for precisely this reason.

Systems exist which allow users to book ELS training electronically. These conventional systems include courses, which may only be taken as an individual course and courses which may be taken as part of a curriculum. A curriculum provides a functionality to build sequenced and unsequenced blocks of trainings of different forms like instructor led trainings (ILT), web based trainings (WBTs) or online tests. A curriculum is a composite training; sometimes, these trainings are called “blended learning”. Curricula provide a high consistency, because
Trainings can be organized in a sequenced way; learners are forced to take a training prior to a second training. On the other hand, trainings may now have a sequence so learners are free to decide which training they take first.
Curricula can be taken with all their mandatory trainings only. In this case, learners are forced to participate in certain trainings prior to taking a final training.

The second aspect is very important for customers, because it guarantees that participants have the required skill-set before they participate. Accordingly, there is a need for a reliable and efficient way to book curriculum exclusive courses in an ELS so that they are only available to users as part of a curriculum and it is guaranteed that participants get their skill set by trainings that are elements of a curriculum. An example would be if there is a curriculum for project leads with a final online test and customers want to ensure that only participants of this curriculum can take this online test.

### SUMMARY

This application describes tools (in the form of methodologies, apparatuses, and systems) for curriculum exclusive booking. The tools may be embodied in one or more computer programs stored on a computer readable medium or program storage device and/or transmitted in the form of a computer data signal in one or more segments via a computer network or other transmission medium.

A method for curriculum exclusive booking in a curriculum management system, according to an embodiment of the present disclosure, includes receiving a request for booking a course, determining based on a value of a first booking option whether the course is allowed to be booked, whether the course is bookable only as part of a curriculum, or whether the course is bookable depending on a value of a second booking option, determining based on the value of the second booking option whether the course is allowed to be booked or whether the course is bookable only as part of a curriculum, if it is determined that the course is bookable depending on the value of the second booking option, and processing the request based on the value of the first booking option or the value of the second booking option.

An apparatus for curriculum exclusive booking in a curriculum management system, according to an embodiment of the present disclosure, includes receiving means for receiving a request for booking a course, first determining means for determining based on a value of a first booking option whether the course is allowed to be booked, whether the course is bookable only as part of a curriculum, or whether the course is bookable depending on a value of a second booking option, second determining means for determining based on the value of the second booking option whether the course is allowed to be booked or whether the course is bookable only as part of a curriculum, if it is determined that the course is bookable depending on the value of the second booking option, and processing means for processing the request based on the value of the first booking option or the value of the second booking option.

A computer storage medium including computer executable code for curriculum exclusive booking may, according to an embodiment of the present disclosure, includes code for receiving a request for booking a course, code for determining based on a value of a first booking option whether the course is allowed to be booked, whether the course is bookable only as part of a curriculum, or whether the course is bookable depending on a value of a second booking option, code for determining based on the value of the second booking option whether the course is allowed to be booked or whether the course is bookable only as part of a curriculum, if it is determined that the course is bookable depending on the value of the second booking option, and code for processing the request based on the value of the first booking option or the value of the second booking option.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a block diagram of an exemplary computer system capable of implementing the method and system of the present disclosure;

FIG. 2 shows a block diagram of a curriculum management system, according to an embodiment of the present disclosure;

FIG. 2A shows a block diagram illustrating an apparatus for curriculum exclusive booking in a curriculum management system, according an embodiment of the present disclosure;

FIG. 2B shows a flow chart illustrating a method for curriculum exclusive booking in a curriculum management system, according to an embodiment of the present disclosure;

FIG. 3 shows an example of a booking scenario associated with the curriculum management system, according to an embodiment of the present disclosure;

FIG. 4 shows an example of granularity settings associated with the curriculum management system, according to an embodiment of the present disclosure;

FIG. 5 shows a block diagram of an implementation of an ELS in which the curriculum management system may be used, according to an embodiment of the present disclosure;

FIG. 6 shows an example of an initial screen of a learning portal in the ELS, according to an embodiment of the present disclosure; and

FIG. 7 shows an example of a booking modification screen that is accessible via the learning portal.

### DETAILED DESCRIPTION

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

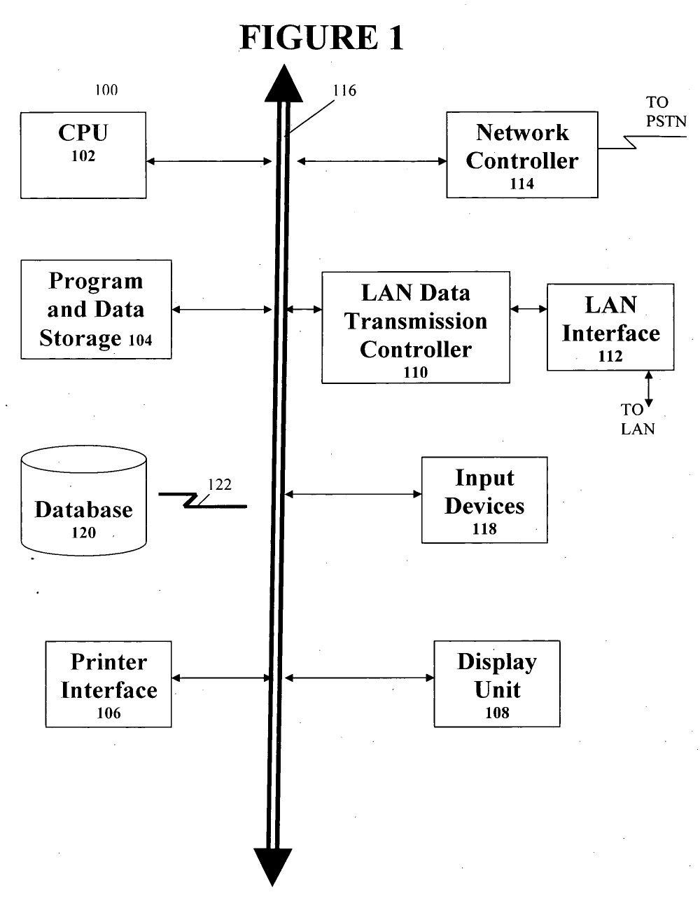

FIG. 1 shows an example of a computer system 100 which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The computer system 100 is merely exemplary. The specific embodiments described herein are illustrative, computer system(s) as referred to herein may include(s) individual computers, servers, computing resources, networks, etc., and many variations can be introduced on these embodiments without departing from the spirit of the disclosure or from the scope of the appended claims.

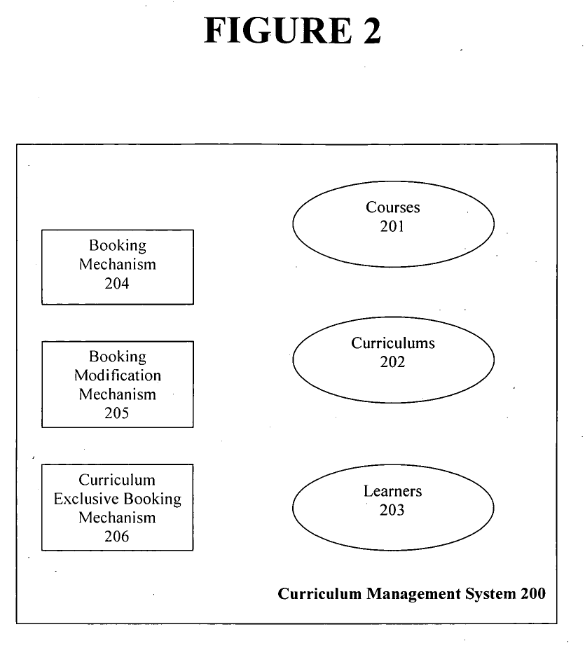

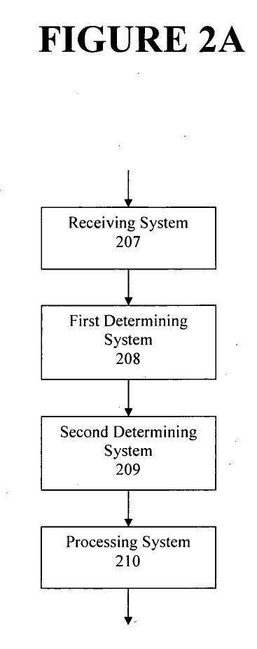

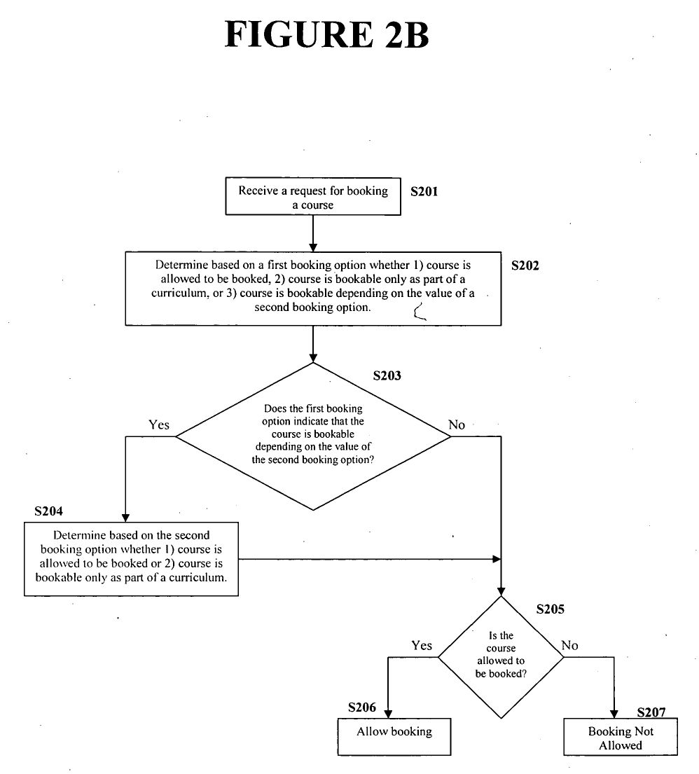

FIG. 2 shows a curriculum management system 200 for an ELS. The curriculum management system manages a set of courses 201, a set of curriculums 202, and a set of learners 203 in the ELS. A course constitutes a training that provides instruction about a particular topic. Associated with each course is information specifying course constraints, such as course start and end dates, course prerequisites, and qualifications imparted by the course.

The set of courses 201 can include different types of courses including web-based courses, classroom courses, and on-the-job courses. An on-the-job course is a course that includes one or more work assignments and a required time interval for completing the work assignments. A classroom course is a live course that is given by an instructor in a fixed location at a fixed time. A web-based course is a course that is delivered over the Internet. With web-based courses, there is typically not a fixed location and there often is not a fixed time either. Examples of web-based courses include on-line tutorial programs and presentations.

A curriculum is a group of two or more courses selected from a set of courses managed by the system. Within the group, the courses are arranged in a sequence that determines the order in which the courses should be taken. Associated with each curriculum is information specifying the curriculum constraints, such as curriculum start and end dates, curriculum prerequisites, and qualifications imparted by the curriculum.

A learner is a user of the ELS that is authorized to book courses or curriculums managed by the curriculum management system. For each learner, the ELS maintains a learner profile that keeps track of the learner's bookings and the qualifications earned by the learner.

Curriculum management system 200 also includes a booking mechanism 204 for booking courses and curriculums, a booking modification mechanism 205 for making modifications to bookings and a curriculum exclusive booking mechanism 206 for allowing courses to be booked as stand-alone courses or as part of a curriculum. The curriculum exclusive booking mechanism 206 can be separate from the booking mechanism 204 or it can be incorporated into the booking mechanism 204.

The curriculum exclusive booking mechanism 206, according to one embodiment of the disclosure, will be discussed with reference to FIG. 2A. The curriculum exclusive booking mechanism 206 includes receiving system 207, first determining system 208, second determining system 209, and processing system 210. The receiving system 207 receives a request for booking a course. The first determining system 208 determines, based on a first booking option, whether the course is allowed to be booked, whether the course is bookable only as part of a curriculum, or whether the course is bookable depending on a value of a second booking option. The second booking option may include information about the course, for example, specific dates that the course is bookable only as part of a curriculum. For example, if a training administrator wants the course to be bookable as part of a curriculum only after a certain date or for a certain amount of time, he/she can specify this information through the second booking option. If it is determined that the course is bookable depending on the value of the second booking option, the second determining system 209 determines, based on the value of the second booking option, whether the course is allowed to be booked or whether the course is bookable only as part of the curriculum. The processing system 210 processes the request based on the value of the first booking option or the value of the second booking option. For example, the processing system 210 either allows the course to be booked or prevents the course from being booked because it is may only be booked as part of a curriculum.

It should be apparent that receiving system 207, first determining system 208, second determining system 209, and processing system 210 can be respective portions of, or routines in, a computer program for curriculum management (and perhaps performs other functions).

A method for curriculum exclusive booking, will be explained below with reference to FIGS. 2A and 2B. The receiving system 207 receives a request for booking a course (Step S201). The first determining system 208 determines, based on a first booking option, whether the course is allowed to be booked, whether the course is bookable only as part of a curriculum, or whether the course is bookable depending on the value of a second booking option (Step S202). If it is determined that the first booking option does not indicate that the course is bookable depending on the value of the second booking option (No, Step S203), then the processing system 210 determines whether the course is allowed to be booked (Step S205). If the processing system 210 determines that the course is allowed to be booked (Yes, Step S205), it allows the booking (Step S206). If the processing system 210 determines that the course is bookable only as part of a curriculum (No, Step S205), it does not allow the booking (Step S207). If the first booking option indicates that the course is bookable depending on the value of a second booking option (Yes, Step S203), the second determining system 209 determines, based on the value of the second booking option, whether the course is allowed to be booked or whether the course is bookable only as part of the curriculum (Step S204). The processing system 210 then determines if the course is allowed to be booked (Step S205). If the processing system 210 determines that the course is allowed to be booked (Yes, Step S205), it allows the booking (Step S206). If the processing system 210 determines that the course is bookable only as part of a curriculum (No, Step S205), it does not allow the booking (Step S207).

Bookings

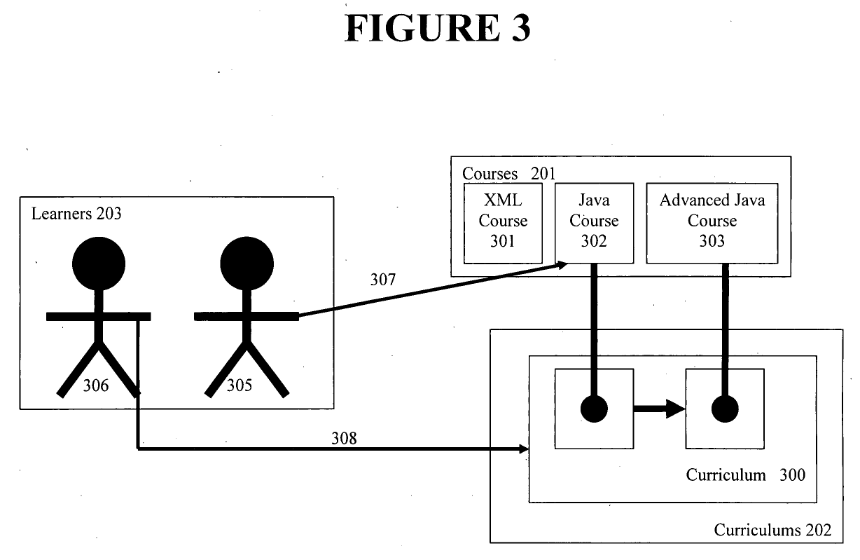

As shown in FIG. 3, an example booking scenario 300 involves a set of courses 201, a set of curriculums 202, and a set of learners 203. The set of courses 201 includes courses 301 which may only be taken as an individual course and courses 302 which may be taken either as an individual course or as part of a curriculum. In this example, the Java course, namely course 302, may be taken individually or as part of a curriculum. Courses are “booked”, meaning that the courses are scheduled to be taken by a learner. Bookings can occur through a variety of methods. For example, a course may be booked electronically from a remote learning station, or via other means, such as by telephone.

The set of learners include a first learner 305 and a second learner 306. In this scenario the first learner 305 books the Java course through an “individual booking”, meaning that the first learner books the Java course by itself, not as part of the curriculum. The second leaner 306 also books the Java course, but through a “curriculum booking” for the curriculum 300, meaning that the second learner is taking the Java course as part of curriculum 300.

Booking Modifications

Once a booking has been made, it can be modified by cancellation, re-booking, or follow-up. Bookings may be modified electronically or via other methods. Cancellation removes a booking from the schedule of bookings. Re-booking shifts or reschedules a booking to a different start date. Follow-up is a bookkeeping operation that is performed by an administrator once a course or a curriculum has ended. During follow-up, any qualifications that are imparted by the course or curriculum are transferred to a learner profile of a learner that successfully completed the course or curriculum (the ELS, as described below, maintains learner profiles containing learner-specific information).

In some cases, the follow-up procedure is dependent on whether the learner that completed the course booked the course as a curriculum booking or as an individual booking. In the case of a curriculum booking, before performing a follow-up, the booking mechanism 204 may need to consider additional conditions that are not required for an individual booking. An example of such an additional condition is the successful completion of a final exam or project. That is, if the learner has not successfully completed a final exam or project, the learner may be denied an indication of successful completion in the learner's profile.

In one implementation, when a course is booked, the booking mechanism 204 creates an attendance link 307 (FIG. 3) that associates the learner with the booked course. For curriculum bookings, the system creates an attendance link 308 that associates the learner with the booked curriculum and additional attendance links (not illustrated) that associate the learner with each of the courses in the booked curriculum. An attendance link indicates a valid booking. An attendance link has a defined start and end date. For classroom courses, the start and end dates of the attendance link correspond to the start and end dates of the course. For web-based trainings, the start and end dates of the attendance link correspond to the period of time which the course content is available on the web. When booking a web-based course, the learner indicates an intended start and end date for his participation in the course. The system then checks to make sure that the participation dates fall within the period of availability of the course content.

The system uses attendance links to identify all the bookings for a particular curriculum. For example, in one implementation, each attendance link has a curriculum participation ID field that indicates which curriculum the bookings belong to. If the booking is an individual booking, then the value of the field is null.

The system also uses the attendance links to keep track of a particular learner's training history. The system archives the attendance links for all courses completed by a particular learner. Each archived link can optionally store information about the learner's performance in the course (e.g., whether the course was successfully completed, or failed, etc.). The archived information can be used for purposes of reporting or documenting a learner-'s training history.

During the cancellation or follow-up process, attendance links are removed and archived. During the re-booking process, the system modifies the attendance link to point to a different occurrence of the same course or curriculum.

Potential Inconsistencies

Modifications to a booking without regard to whether the booking is an individual booking or a curriculum booking can render other bookings invalid. For example, supposed that in the example scenario of FIG. 3, after the bookings have been made, the booking modification mechanism 205 receives user input from both learners 305 and 306 requesting a cancellation of their booking for the Java course, namely course 302. Suppose also that the Java course is a prerequisite to taking the rest of the curriculum 300. If the booking modification mechanism 205 were to handle both cancellation requests in the same manner, this would lead to inconsistencies because the two bookings in question have different constraints. That is, the booking for the first learner is an individual booking, while the bookings for the second learner is a curriculum booking. In the latter case, cancelling the booking for the lava course would render invalid the booking for the curriculum 300 because the second learner would no longer have the necessary prerequisite (i.e., the Java course) to take the rest of the curriculum 300.

To manage such potential inconsistencies, the booking modification mechanism 205 distinguishes between individual bookings and curriculum bookings, and handles them differently. Various implementations are possible. In one implementation, the booking modification mechanism permits booking modifications only for the curriculum as a whole (this is referred to as the “curriculum approach.”). Under this approach, the requested cancellation made by the second learner in the above-described booking cancellation scenario would not be permitted by the booking modification mechanism 205. Under the curriculum approach, the only permissible way to cancel the booking of the Java course would be to cancel the booking to the curriculum 300 as a whole.

In some cases, the curriculum approach to cancellation may be too limiting. For example, in some cases, there may be no course prerequisites for the courses in the curriculum, so cancelling a booking for one of the courses in the curriculum might not render the remaining bookings invalid.

Thus, alternatively, the booking modification mechanism 205 may be configured, e.g., by system administrators, to follow the curriculum approach for booking modifications or not to follow the curriculum approach. For each type of modification (e.g., cancellation, re-booking, or follow-up), the administrator decides whether to select the curriculum approach which allows booking modifications only for a curriculum as a whole but not for individual courses within a curriculum.

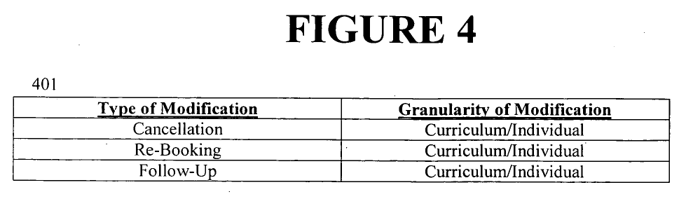

In one implementation, as illustrated in FIG. 4, the booking modification mechanism includes a granularity setting 401 that can be set to either the curriculum approach or the individual approach. As illustrated, the granularity setting can be configured differently for different types of modifications. For example, the granularity can be set to the curriculum approach for cancellations, but to the individual approach for re-bookings. Under this configuration, learners cannot cancel an individual course within a curriculum, but they can re-book the course to a different date. Other combinations are also possible, as shown.

The following describes how the booking modification mechanism 205 performs each type of booking modification under the curriculum and individual approaches.

Cancellation

Under the curriculum approach, cancellation of bookings for individual courses within a curriculum is not permissible. Instead, the curriculum is cancelled as a whole. By contrast, the individual approach has three variants (described below).

Under the first variant (called “Cancel Invalid Bookings”), in addition to performing a requested cancellation, booking modification mechanism 205 also performs additional cancellations to cancel any other bookings that are rendered invalid by performing the requested cancellation. This involves examining the bookings for other courses in the curriculum and checking for dependencies, for example, checking the qualifications imparted by the cancelled course against the prerequisites for the remaining courses. In this regard, each course in the ELS contains metadata that defines dependencies among the courses. In this variant, booking modification mechanism 205 examines the metadata of a target course to determine the courses that depend on the target course (i.e., the courses for which the target course is a prerequisite). Booking modification mechanism 205 in this manner identifies the courses that depend on the target course and cancels their bookings accordingly.

Under the second variant (“Cancel To End”), instead of examining the bookings (which can be time-consuming), booking modification mechanism 205 simply cancels any bookings for courses that are later in the curriculum sequence than the cancelled course. In this regard, a curriculum is defined by data that identifies, inter alia, the courses that make up the curriculum and the order in which those courses should be presented. As noted, individual metadata associated with a course may define dependencies. Data defining the curriculum may also keep track of dependencies among courses. In this case, booking modification mechanism 205 examines the data associated with a curriculum (and, if necessary, metadata associated with a course) to identify courses that are later in the curriculum sequence than the course targeted for cancellation.

Under the third variant, the requested cancellation is performed without performing any additional consistency measures. That is, the target course is simply cancelled without regard to dependencies. This approach could lead to inconsistencies in some cases (e.g., to cancelling a course upon which other courses in a curriculum depend), but it is made available as a configuration option because in some implementations of the ELS, there may be no dependencies among courses.

Re-Booking

Under the curriculum approach, re-booking of an individual course within a curriculum is not permissible. Instead, the curriculum is re-booked as a whole.

Under the individual approach, individual re-bookings are permissible, but booking modification mechanism 205 first performs a consistency check before allowing the rebooking to occur. The consistency check involves checking the course dependencies to make sure that courses which should be taken prior to other courses in the curriculum have not been re-booked in a manner that violates the course dependencies. As noted above, individual course metadata and/or data that define a curriculum may be examined to determine dependencies among courses in a curriculum.

Follow-Up

Typically, for an individual booking, once the course is completed, the ELS performs follow-up (transfers, qualifications, etc.) immediately for each booking associated with the course. For curriculum bookings, the follow-up procedure involves performing follow-up at the curriculum-level and also at the course-level.

Follow-up at the curriculum-level involves transferring any qualifications that are imparted by successful completion of the curriculum. As discussed above, the successful completion of the curriculum may depend on additional conditions beyond successful completion of each course within the curriculum.

Follow-up at the course-level involves transferring any qualifications that are imparted by successful completion of the course. An issue that arises with respect to course-level follow-up is: Should the course-level follow-up for a particular course be performed as soon as the course is completed, or should the follow-up be deferred until all remaining courses in the curriculum have been completed?

Under the curriculum approach, the booking modification mechanism 205 determines whether the learner booked the course as an individual booking or as a curriculum booking. If the booking is an individual booking, booking modification mechanism 205 performs follow-up without waiting for completion of other courses. If the booking is a curriculum booking, booking modification mechanism 205 defers follow-up until the entire curriculum (or some portion thereof) is complete. For curriculum bookings, booking modification mechanism 205 performs follow-up at both the curriculum-level and at the course-level (e.g., performing curriculum-level follow-up before performing course-level follow-up). What this means is that booking modification mechanism 205 updates a learner's profile, e.g., to reflect successful completion of both a curriculum and a course within that curriculum. Other information may also be updated.

Under the individual approach, booking modification mechanism 205 does not defer course-level follow-up for curriculum bookings. Instead, all bookings (curriculum or individual) can be followed-up right away at the course-level, and then for the curriculum bookings, an additional follow-up occurs at the curriculum-level once the entire curriculum is completed.

The booking modification mechanism 205 can be configured with respect to whether the curriculum approach or the individual approach is used for the follow-up procedure.

The above-described techniques have been described in the context of a curriculum management system for an ELS. In addition to the curriculum management system, the ELS generally includes other systems as well, for example, an authoring system for creating course content, a content management system for storing created content, and/or a player system for delivering course content. One such ELS is the Learning Solution® available from SAP® AG of Walldorf, Germany.

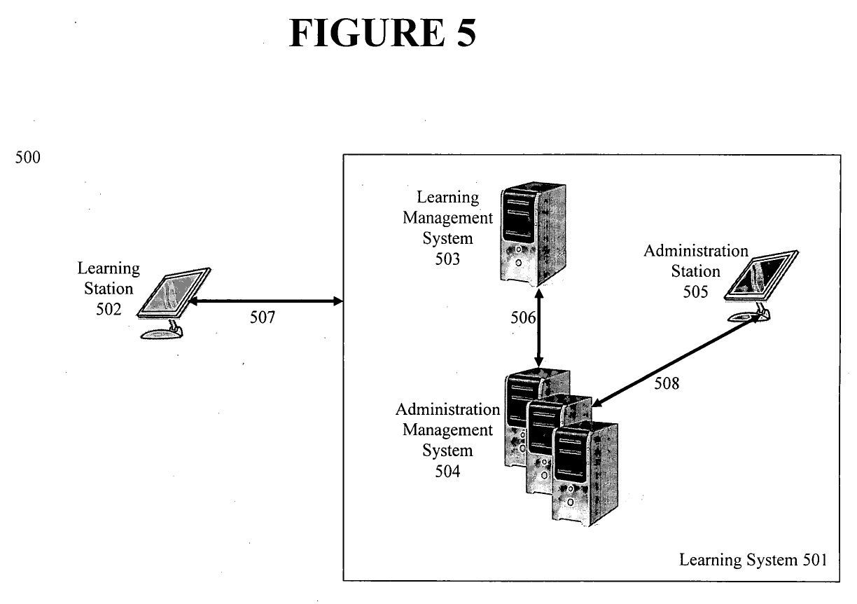

FIG. 5 shows one implementation 500 of an ELS in which the curriculum management techniques described herein may be used. In this implementation, the ELS includes a learning system 501 and a learning station 502 through which a learner accesses the learning system 501.

Learning System

The learning system 501 includes a learning management system 503 and an administration management system 504. An administrator accesses the administration management system through an administration station 505.

Administration management system 504 also includes a database of learner accounts. Each learner account includes demographic data about the learner (e.g., name, address, account number), booking information for one or more courses and/or curriculums, and a learner profile that records tests completed, skills and knowledge acquired, qualifications completed for courses and/or curriculums within the ELS. In one implementation, the administration management system 504 may be implemented using SAP® R/3 Server, Release 4.6C extended with the Learning Solution® plug-in, available from SAP® AG of Walldorf, Germany.

Learning management system 503 includes mechanisms for presenting training materials to the learner. One such mechanism is a content player that retrieves training material from a content repository of a content management system (not shown). The content player also applies a learner-selectable learning strategy to the obtained training material to generate a navigation tree or path for the learner. The navigation tree or path is used to suggest a route through training material for the learner and to generate a presentation of training material to the learner. The content player can be implemented using a J2EE Engine such as SA® J2EE Engine.

Learning management system 503 exchanges information with administration management system 504 through a communication link 506. The exchange information can include information that updates the learner account information as the learner progresses through the training material to indicate, for example, competencies gained, tests passed, and training completed via the ELS.

Learning Station

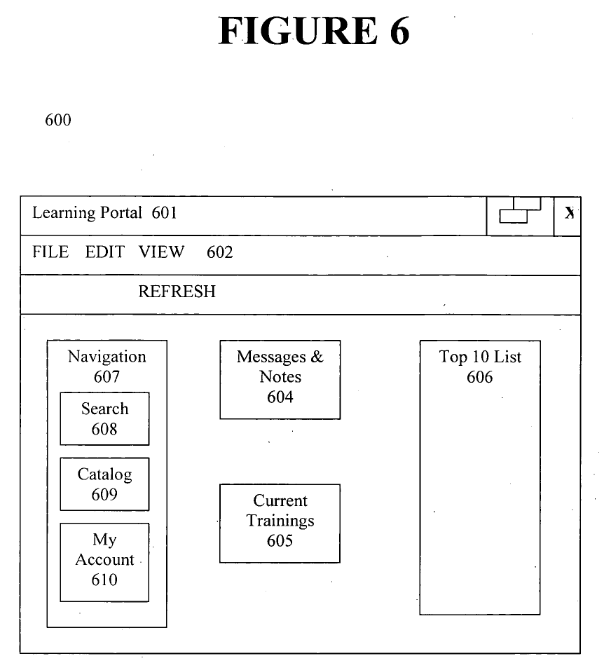

Learning station 502 includes software that accesses, interprets, and presents training materials and associated information to a learner. Learning station 502 allows a learner to interact with the materials and with other aspects of the ELS. A browser running on the learning station communicates with learning system 501 through communication link 507. The browser displays a learning portal (i.e., a user interface, which is described below with respect to FIG. 6) through which users can access learning system 501. The browser can be any software application that interprets and processes a markup language, such as Hypertext Markup Language (HTML), Standard Generalized Markup Language (SGML), Dynamic Hypertext Markup Language (DHTML), Extensible Markup Language (XML), or Extensible Hypertext Markup Language (XHTML). The functionality of the browser can be extended using a software plug-in that allows the browser to interpret, process, and present different types of information. Examples of such plug-ins are Java, Active X, JavaScript, and Flash plug-ins.

An administration station 505 includes similar elements to the learning station. Such elements allow the administration station 505 to interact with administration management system 504 through communication link 508.

Learning Portal

FIG. 6 illustrates an initial screen 600 for the learning portal. Initial screen 600 includes a title bar 601, a menu bar 602, and a tool bar 603. In addition, initial screen 600 includes a number of sections, includes a message and notes section 604, a current trainings section 605, a Top 10 List section 606, and a navigation section 607.

Message and notes section 604 provides access to information about training provided via the ELS. For example, an employer may use the messages and notes section 604 to distribute company-wide information about training to all employees. Messages and notes section 604 also may be used by the employer to determine whether an employee has received, read, and/or confirmed receipt of information about training. For example, administration management system 504 may determine when a message is delivered to an employee, when an employee accesses a note or message using message and notes section 604, and/or when an employee confirms or acknowledges receipt of a message.

Message and notes section 604 includes a mandatory trainings section containing training that is prescribed for the learner, a qualifications section displaying essential requirements for the learner (e.g., related to a learner's job description), and an area displaying scheduled dates of training for which the employee is prebooked (not shown).

Current trainings section 605 provides the learner with detailed information on personal training activities that are planned and/or are currently in process. Current training may include, but is not limited to, training that the learner has booked for a fixed date in the future (e.g., classroom training) and training that the learner has booked that has no scheduled training date (e.g., Web-based training). The learner also may start an active Web-based training by selecting a “Start Now” hyperlink (not shown). Depending on the type of training, the current training section 605 may display training details (e.g., information from the training catalog) or details about a scheduled training (e.g., participant list or training location).

The Top 10 section 606 displays a list of the training most frequently booked by the ELS. Optionally, the Top 10 section also displays a specialized training list that lists training specific to a particular company, university, or organization.

Navigation section 607 displays controls for navigating through the learning portal. The navigation section 607 includes links to a search tool 608, the training catalog 609, and the learner account 610. Navigation section 607 may also include links to other screens accessible via the learning portal.

The search tool section 608 is used to search for training using a keyword contained in a title or a description of the training. The search function may be used to find a training without having to browse through the training catalog. For example, if a learner wants to improve his or her knowledge of English, the learner may enter the keyword English and start a search. A resulting hit list (not shown) displays all training and delivery methods found that have the keyword English in the training title and description. The learner may select a training from the hit list and display further details about the training, such as training dates or prerequisite qualifications for the training.

The search tool 608 includes an extended search feature that may be used to restrict the search criteria, for example, whether the keyword search should be executed for the training title or the training description. The learning interface may be automatically configured to display the extended search hyperlink if the search results contain more than a predetermined number of entries (e.g., more than 20 entries).

The training catalog (not shown) allows a learner to navigate through any training offered by the ELS. Training may be provided using several different delivery methods, such as online learning or classroom training. As described above, the learner may use the search features to find a specific training in the catalog.

Training may also be accessed from the list of subject areas in navigation section 607 and from the overall view provided by the training catalog. Subject areas constitute a thematic structuring of the offered trainings. The use of subject areas enables the training to be structured thematically rather than hierarchically and thus present a picture of the overall structure of the trainings. The learner may access a detailed screen (not shown) of a subject area and training.

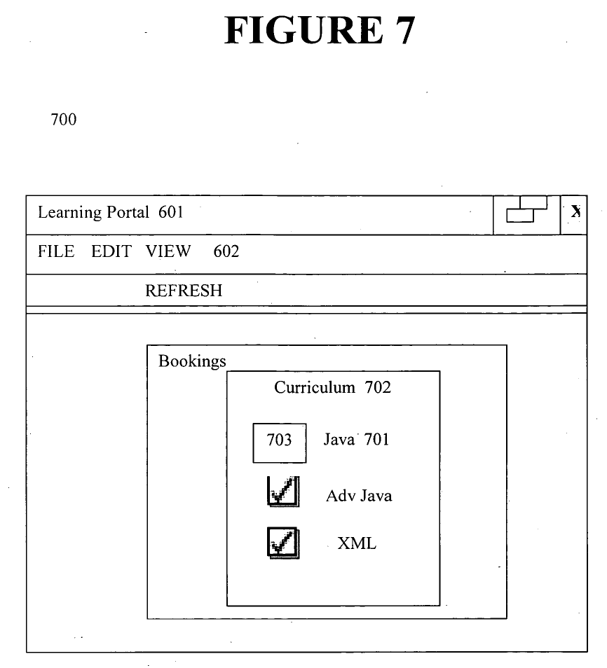

FIG. 7 illustrates a booking modification screen 700 which constitutes part of the learning portal. In FIG. 7, the modification being illustrated is cancellation of an individual course booking 701 within a curriculum of booking 702. The course booking 701 is cancelled by deselecting a check box 703 correlated with the course booking 701. Through such screens, learners can place bookings and modify bookings without administrative intervention. Processes for placing and modifying bookings are described herein above. Alternatively, an administrator may place a booking or modify a booking on behalf of a learner. Administrators may use the same, or different, processes as learners to place or modify a booking.

The curriculum management system can be implemented in digital electronic circuitry, or in computer hardware, firmware, software, or in combinations of them. The curriculum management system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the curriculum management system can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, embodiments of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The curriculum management system can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the invention, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other.

The curriculum management system has been described in terms of particular embodiments. Other embodiments are within the scope of the following claims. For example, although the curriculum management system has been described as a component in a larger ELS, it can also be implemented in other systems or as a stand-alone system.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

What is claimed is:

1. A method for curriculum exclusive booking, comprising:
receiving a request for booking a course;
determining based on a value of a first booking option whether the course is allowed to be booked, whether the course is bookable only as part of a curriculum, or whether the course is bookable depending on a value of a second booking option;
determining based on the value of the second booking option whether the course is allowed to be booked or whether the course is bookable only as part of a curriculum, if it is determined that the course is bookable depending on the value of the second booking option; and
processing the request based on the value of the first booking option or the value of the second booking option.

2. The method of claim 1, wherein the request is allowed if it is determined that the course is allowed to be booked based on the value of the first booking option or the value of the second booking option.

3. The method of claim 1, wherein the request is denied if it is determined that the Course is bookable only as part of a curriculum based on the value of the first booking option or the value of the second booking option.

4. The method of claim 1, wherein the first booking option is a tri-state flag.

5. The method of claim 1, wherein the second booking option is a two-state flag.

6. The method of claim 1, wherein the second booking option is utilized when a course is bookable only as part of the curriculum for a specific amount of time on or after a date certain.

7. A program storage device readable by a computer, tangibly embodying a program of instructions executable by the computer to perform the method of claim 1.

8. A computer data signal transmitted in one or more segments in a transmission medium which embodies instructions executable by a computer to perform the method of claim 1.

9. A computer system comprising:
a processor; and
a program storage device readable by the computer system, tangibly embodying a program of instructions executable by the processor to perform the method of claim 1.

10. An apparatus for curriculum exclusive booking, comprising:
receiving means for receiving a request for booking a course;
first determining means for determining based on a value of a first booking option whether the course is allowed to be booked, whether the course is bookable only as part of a curriculum, or whether the course is bookable depending on a value of a second booking option;
second determining means for determining based on the value of the second booking option whether the course is allowed to be booked or whether the course is bookable only as part of a curriculum, if it is determined that the course is bookable depending on the value of the second booking option; and
processing means for processing the request based on the value of the first booking option or the value of the second booking option.

11. The apparatus of claim 10, wherein the request is allowed if it is determined that the course is allowed to be booked based on the value of the first booking option or the value of the second booking option.

12. The apparatus of claim 10, wherein the request is denied if it is determined that the course is bookable only as part of a curriculum based on the value of the first booking option or the value of the second booking option.

13. The apparatus of claim 10, wherein the first booking option is a tri-state flag.

14. The apparatus of claim 10, wherein the second booking option is a two-state flag.

15. The apparatus of claim 10, wherein the second booking option is utilized when a course is bookable only as part of the curriculum for a specific amount of time on or after a date certain.

16. A computer readable storage medium including computer executable code for curriculum exclusive booking, comprising:
code for receiving a request for booking a course;
code for determining based on a value of a first booking option whether the course is allowed to be booked, whether the course is bookable only as part of a curriculum, or whether the course is bookable depending on a value of a second booking option;
code for determining based on the value of the second booking option whether the course is allowed to be booked or whether the course is bookable only as part of a curriculum, if it is determined that the course is bookable depending on the value of the second booking option; and
code for processing the request based on the value of the first booking option or the value of the second booking option.

17. The computer readable storage medium of claim 16, wherein the request is allowed if it is determined that the course is allowed to be booked based on the value of the first booking option or the value of the second booking option.

18. The computer readable storage medium of claim 16, wherein the request is denied if it is determined that the course is bookable only as part of a curriculum based on the value of the first booking option or the value of the second booking option.

19. The computer readable storage medium of claim 16, wherein the first booking option is a tri-state flag.

20. The computer readable storage medium of claim 16, wherein the second booking option is a two-state flag.

21. The computer readable storage medium of claim 16, wherein the second booking option is utilized when a course is bookable only as part of the curriculum for a specific amount of time on or after a date certain.
